(19) United States
(12) Patent Application Publication
(10) Pub. No.: US 2006/0276371 A1
(43) Pub. Date: Dec. 7, 2006

(54) Coacervate systems having soil anti-adhesion and anti-deposition properties on hydrophilic surfaces

(76) Inventors: Anthony Schreiner, Whitehall, PA (US); Mikel Morvan, Princeton, NJ (US)

Correspondence Address: MIALEEKA WILLIAMS;RHODIA INC., (CN 7500), 8 CEDAR BROOK DRIVE, CRANBURY, NJ, 08512-7500, US

(21) Appl. No.: 11/445,115

(22) Filed: Jun. 1, 2006

Related U.S. Application Data
(60) Provisional application No. 60/686,207, filed on Jun. 1, 2005.

(51) Int. Cl. C11D 3/37

(52) U.S. Cl. 510/475

(57) ABSTRACT

A hard surface cleaning composition comprising a coacervate complex having a molar charge ratio Z greater than 0.1, wherein said coacervate complex comprises a copolymer and at least one of two components selected from a surfactant or a polymer, whereby the copolymer is cationic if the polymer, surfactant, or combination of polymer and surfactant is anionic, or the copolymer is anionic if the polymer, surfactant, or combination of polymer and surfactant is cationic, and a method of cleaning hard surfaces, are disclosed.

### CROSS REFERENCE TO RELATED APPLICATIONS

Benefit of Provisional Application Ser. No. 60/686,207 filed Jun. 1, 2005 is claimed.

### FIELD OF THE INVENTION

The invention relates to coacervates for use in cleaning compositions for hard surfaces, such as glass, mirror, ceramic, tiles and other kitchen and bathroom surfaces. More particularly, the invention relates to providing long-lasting anti-adhesion and/or anti-deposition properties to hard surfaces. Even more particularly, the present invention provides long-lasting anti-deposition and/or anti-adhesion properties to hard surfaces which prevent or reduce soap-scum build-up, and hard water mineral-deposition.

### BACKGROUND OF THE INVENTION

Detergent or cleaning compositions make it possible to clean industrial and domestic hard surfaces. Cleaning compositions generally contain surfactants; solvents, for example, alcohol to possibly facilitate drying; sequestering agents; and bases or acids to adjust the pH. The surfactants are generally nonionic and anionic combinations, or nonionic and cationic combinations. A frequent disadvantage of these cleaning compositions is that the subsequent contact of the hard surface with water leads to the formation of hard water deposits when the surface dries. Moreover, conventional cleaning compositions merely clean the surface, but do little to prevent future soiling.

A solution to this problem was proposed in Ep-a-1196527, Ep-a-1196528 and Ep-a-1196523. These patents propose to deposit on the hard surface a cleaning composition containing a water-soluble amphoteric organic copolymer derived from a cation monomer and an anion or potentially anionic monomer in a sufficient quantity to make the surface absorbent or to improve the hydrophilicity of the surface. This is done in order to obtain the weakest possible contact angle between the treated surface and a water drop and also to ensure the water retention in the vicinity of the treated surface lasts after treatment.

It would be advantageous to provide a cleaning composition for hard surfaces which imparts improved anti-deposition and/or anti-adhesion properties to a hard surface, particularly anti-soil deposition and anti-soil adhesion properties. It would also be advantageous to provide a cleaning composition for hard surfaces which prevents or minimizes hard water deposits, soap scum, and other mineral deposits.

### BRIEF DESCRIPTION OF THE DRAWINGS

FIG. 1 shows the scattering properties of mixed solutions of block copolymers and oppositely charged surfactant.

FIG. 2 shows before and after photos of a black ceramic tile treated with the model soap scum and cleaned with a hard surface cleaning composition in accordance with the invention.

### BRIEF SUMMARY OF THE INVENTION

In a first aspect, the present invention is directed to a hard surface cleaning composition comprising a coacervate complex having a molar charge ratio Z greater than 0.1, wherein said coacervate complex comprises a copolymer and at least one of two components selected from a surfactant or a polymer, whereby the copolymer is cationic if the polymer, surfactant, or combination of polymer and surfactant is anionic, or the copolymer is anionic if the polymer, surfactant, or combination of polymer and surfactant is cationic.

In another aspect of the present invention, there is provided a hard surface cleaning composition comprising a coacervate complex, wherein said coacervate complex comprises diblocks of Padamquat-b-PAM (Poly(trimethylammonium ethyl acrylate methyl sulfate)-b-PolyAcrylamide) or copolymers of Poly(trimethylammonium propyl methacrylamide chloride-co-methoxy polyethylene glycol monomethacrylate).

In yet another aspect of the present invention, there is provided a hard surface cleaning composition comprising a coacervate complex in an effective amount to provide anti-deposition properties to the hard surface.

In still yet another aspect of the present invention, there is provided a hard surface cleaning composition comprising a coacervate complex in an effective amount to provide anti-adhesion properties to the hard surface.

The present invention is also directed to a cleaning composition for pre-treating a hard surface comprising a coacervate complex having a molar charge ratio Z greater than 0.1, wherein said coacervate complex comprises a copolymer and at least one of two components selected from a surfactant or a polymer, whereby the copolymer is cationic if the polymer, surfactant, or combination of polymer and surfactant is anionic, or the copolymer is anionic if the polymer, surfactant, or combination of polymer and surfactant is cationic.

### DETAILED DESCRIPTION OF THE INVENTION

By pre-treating the surface or cleaning a surface with a coacervate complex in accordance with the invention, soil adsorption can be minimized or eliminated, thus, allowing for the soil to be easily rinsed off with minimal mechanical effort. As used herein, the term “soil” includes but is not limited to, fatty organic compounds, deposits of soaps and their metal salts, the deposit of vegetable of hydrocolloids type or polysaccharides, salt deposits, and organic particles present in the ambient air.

Cleaning or treating a hard surface with a composition in accordance with the invention modifies the surface so as to allow the composition to continue providing anti-adhesion and/or anti-deposition properties even after the treated hard surface has been rinsed. The properties provided by the composition of the invention can lasts throughout multiple cycles of soiling and rinsing. As such a composition in accordance with the invention provides long-lasting soil anti-adhesion and/or soil anti-deposition properties. Moreover the presence of coacervate complexes in accordance with the invention provides improved cleaning capacity in cleaning formulations. By “long-lasting anti-deposition and/or anti-adhesion properties,” it is meant that the treated surface preserves these properties in the course of time, including after later contacts with soil (for example rainwater, toilet water flushing, fat or oil splashes, or soaps). The “long-lasting” properties of the present invention can be observed up to and beyond ten cycles of rinsing, even in certain particular cases where the rinsing cycles are numerous (in the case of the toilets for example), preferably beyond 100 cycles of rinsing.

The expression “to confer anti-deposition properties on a treated surface” means more particularly that a treated surface, put in contact with soil in a mainly aqueous medium, will not tend “to collect” the aforementioned soil, which significantly decreases the deposit of the soil on surface.

The expression “to confer anti-adhesion properties on a treated surface” means more particularly that a treated surface is likely to only interact very slightly with new or subsequent soil deposits, which allows an easy removal of the soil from dirtied treated surfaces. During the drying of soil on the treated surface, the bonds developed between the soil and the treated surface are very weak due to the presence of the coacervates of the invention; thus, to break these bonds requires less cleaning energy or effort.

The use of coacervate complexes on hard surfaces in accordance with the invention improves the hydrophilicity of the hard surface. This benefit can be particularly useful in the formulas for cleaning windows and mirrors and, in particular, bathroom windows and mirrors. Moreover, improving hydrophilicity of the hard surface prevents the formation of water spots. However, it should be understood that the invention may be useful on both hydrophilic and hydrophobic surfaces.

The term “hard surface” is to be taken in the broadest sense. Hard surfaces are generally non-textile surfaces, which can be domestic or industrial. Hard surfaces can be any suitable surface, for example, ceramic (including sinks, bath-tubs, tile, floors, or toilets); glass or mirror (including interior, exterior, buildings, or vehicles); metal (including internal or external walls of engines, blades, panels, or pipes); and synthetic resins (for example body or interior surfaces of motorized vehicles) are all hard surfaces. “Hard surfaces”, as used herein, does not include very porous and fibrous surfaces. “Hard surfaces” should be distinguished from textile surfaces, for example, fabrics, fitted carpet, clothing or other fabrics made out of natural, artificial or synthetic materials.

A composition in accordance with the invention can be universal or more specific while providing anti-adhesion and anti-deposition properties for various applications. For example, a composition for the cleaning of bathrooms in accordance with the invention may prevent or reduce, in particular, the deposit of salts of soap and limestone around bathtubs and sink; in kitchens, the aforementioned composition makes it possible to improve cleaning of surfaces soiled by unsaturated fatty acids likely to cross-link over time by allowing for easier removal of fatty acids on treated surfaces; on floors, the aforementioned composition makes it possible to improve the removal of dust, or other soil, for example, clay, dirt, sand, and mud, allowing the floor to be more easily cleaned via simple sweeping instead of scrubbing or brushing; for toilets, the aforementioned composition makes it possible to avoid the adhesion of traces of excrements on the surface, thereby allowing the flow of the water in toilet to provide sufficient force to eliminate or remove these traces, accordingly the use of a scrub brush may be eliminated; for windows or mirrors, the aforementioned composition makes it possible to avoid the deposit of mineral or organic particulate stains on surface; for dishware and eating utensils, whether via hand-washing or using an automatic dishwashing machine, the aforementioned composition allows, in the case of hand- washing easier removal of residual dried soil and “squeaky clean” surfaces, namely that the surface “grates” under the effect of a friction with the finger and in the case of dishwashing machines, the aforementioned composition allows the anti-redeposition of the food stains and insoluble calcium salt, and brings brightness to the utensils and dishware, the composition also makes it possible not to have to pre-wash the utensils and dishware before placing them into the dishwasher.

Accordingly, a composition in accordance with the invention may be for domestic or industrial use and can be universal or more specific, like a composition for cleaning—engines, steel blades, sinks, tanks, dishware exterior or interior surfaces of a buildings,—exterior or interior windows of buildings. It should be noted that coacervate complexes and composition containing said complexes can be presented in various forms and can be used in multiple ways in accordance with the invention. Accordingly, the compositions of the invention can be in the form of a liquid, optionally gelled, to deposit the coacervate complex, in particular by spraying directly on surfaces to be cleaned, or provided as a rinse or on a sponge or other support (cellulose article for example, woven or non-woven material) before being applied to the surface to be treated.

In accordance with the invention, preferably the coacervate complex is present in the composition in an effective quantity to provide anti-deposition and/or anti-adhesion properties to the hard surface. A composition in accordance with the invention preferably contains, depending on the application, from 0.001 to 10% by weight of the coacervate complex.

The pH of the composition or the pH of use of the composition according to the invention can vary, according to the applications and surfaces to be treated, from 0.5 to 14. The pH extremes are traditional in industrial applications. In domestic applications, the pH is preferably from 1 to 13.

The aforementioned composition can be implemented for the cleaning or the rinsing of hard surfaces, in quantity such as, after possible rinsing and drying, the quantity of coacervates deposited on surface is 0.0001 to 10 mg/m², preferably from 0.001 to 5 mg/m² of the treated surface.

Aqueous solutions of the complexes of the invention can be sprayed or pipetted onto a hard surface and either rinsed off or allowed to dry. Once treated, the surface will resist the adsorption of soil. Upon rinsing, the soil will generally wash away within 1 minute or less.

Coacervate complexes in accordance with the invention are preferably formed in an aqueous medium when hydrophilic polyelectrolyte/ neutral copolymers are mixed with an oppositely charged surfactant or polyelectrolyte at a molar charge ratio Z of surfactant or polyelectrolyte to polymer greater than 0.1. The coacervate complexes remain unaffected by additional charged or neutral surfactants. Preferred coacervate complexes comprise diblocks of Padamquat-b-PAM (Poly(trimethylammonium ethyl acrylate methyl sulfate)-b-PolyAcrylamide) or copolymers of Poly(trimethylammonium propyl methacrylamide chloride-co-methoxy polyethylene glycol 2000 monomethacrylate) (referred to as Maptac-co-PEG2000 MA) mixed at any pH with one of the following anionic surfactants: sodium dodecyl sulfate, sodium dedecylbenzene sulfonate, or one of the following polyelectrolytes: poly(acrylic acid) when the composition pH>9, or poly(styrene sodium sulfonate).

Polyelectrolyte/neutral copolymers coupled with an oppositely charged surfactant and/or polyelectrolyte form coacervates above Z=0.1, where Z is the stoichiometric ratio of the chargeable groups. As an example, poly(trimethyl ammonium ethyl acrylate methyl sulfate)-b-poly(acrylamide) (Padamquat-PAM) having a number average molecular weight of 11K-30K (41K total) coupled with the anionic surfactant sodium dodecyl sulfate (SDS) would yield the following equation for finding the charge ratio Z: Z=[S]/(41[P]), where [S] and [P] are the molar concentrations for the surfactant and for the polymer, and the denominator has the number 41 due to the fact that Padamquat with a monomer molecular weight of 269 g/mol, an 11K chain contains 41 monomer units and therefore 41 charges. Based on this definition, Z=1 would represent an isoelectric solution, which is a solution characterized by the same number densities of positive and negative chargeable ions. Describing mixed solutions in terms of Z allows for the comparison of polymers with different structures and molecular weights. The parameter Z also appears to be a critical quantity in the formation of the colloidal complexes. Solutions of homopolyelectrolytes and oppositely charged surfactants at the stoichiometric ratio Z=1 usually exhibit a macroscopic phase separation. Shortly after mixing, the polymer/surfactant solution become turbid, and if centrifuged, it would display two well-separated phases.

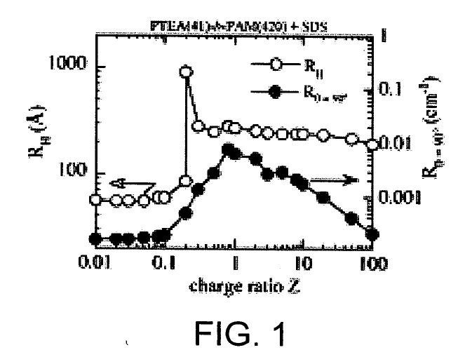

FIG. 1 displays the scattering properties of mixed solutions of block copolymers and oppositely charged surfactant as defined in the above example at room temperature. These properties are the hydrodynamic radius RH (left scale) and the Rayleigh ratio R_{θ} (q,c) at q=2.3×10⁻³ Å⁻¹ and c=1 wt % (right scale) as a function of the charge ratio Z. Z=0 stands for a solution comprised only of polymers, and Z=∞ represents a solution of only surfactant. At low values of Z, typically below 0.1, the scattering intensity is independent of Z, and it remains at the level of the pure polymer. As Z increases, there exists a critical charge ratio noted Z_{c} and comprised between 0.1 and 1, above which the Rayleigh ratio increases noticeably. R_{θ} (q,c) then levels off in the range Z=1-10 and slowly decreases at higher Z values.

Having a Z>0.1 is important for the formation of coacervates. At isoelectric conditions (Z=1) yields optimum performance. Formation and performance of coacervates is not hindered by Z>1. The definition of Z is set forth in the article “Electrostatic Self-Assembly of Oppositely Charged Copolymers and Surfactants: A Light, Neutron, and X-ray Scattering Study”; Macromolecules (2004), 37(13), 4922-4930 by Jean-Francois Berret et. al., which is hereby incorporated by reference.

The cleaning compositions for hard surface cleaning or rinsing in aqueous or polar solvent mediums of the invention include at least a surface-active agent and a coacervate complex.

As used herein, the molecular weight of a polymer, a copolymer, a moiety, a graft, a side-chain, a core, a branch, a block or a backbone refers to the weight-average molecular weight of said polymer, copolymer, moiety, graft, side-chain, core, branch, block or backbone. The weight-average molecular weight of the polymer or copolymer can be measured by gel permeation chromatography (GPC).

As used herein, the molecular weight of a graft, side-chain, core, branch, block or backbone refers to the molecular weight calculated from the amounts of monomers, polymers, initiators and/or transfer agents used to make the said graft, side-chain, core, branch, block or backbone. The ratios by weight between moieties refer to the ratios between the amounts of the compounds used to make said moieties, considering an extensive polymerization.

Typically, the molecular weight M of a block, graft, side-chain, branch, core or backbone is calculated according to the following formula:
M=ΣMᵢ*n/n_{precursor}
wherein Mᵢ is the molecular weight of a monomer i, nᵢ is the number of moles of a monomer i, and n_{precusor} is the number of moles of a compound the macromolecular chain of the block, graft, side-chain, branch, core or backbone will be linked to. Said compound may be a transfer agent or a transfer group, a previous block, or a graft or reactive side-chain. If it is a previous block, the number of moles may be considered as the number of moles of a compound the macromolecular chain of said previous block has been linked to, for example a transfer agent or a transfer group. It may be also obtained by a calculation from a measured value of the molecular weight of said previous block. If two blocks are simultaneously grown from a previous block, at both ends, the molecular weight calculated according to the above formula should be divided by two.

As used herein, a unit deriving from a monomer is understood to mean a unit that may be directly obtained from said monomer by polymerization.

The charge ratio, Z, is defined as the mole ratio between the amount of charges from a surfactant (b) and/or polymer (c) and the amount of charges resulting from copolymer (a).

Copolymer (a) can be any suitable polymer. For example, copolymer (a) may be a block copolymer or comb copolymer. Preferably, block copolymers in accordance with the invention comprise at least two blocks described herein as part A and part B, whereby part A corresponds to one block, and part B corresponds to another block. Part A may also optionally comprise a composition gradient. Preferably, comb copolymers or grafted copolymers, in accordance with the invention comprise a backbone and side chains, described herein as part A and part B, whereby part A corresponds to the backbone and part B corresponds to side chains, or vice versa.

Part A is usually defined by the repeating units it comprises. A part may be defined by naming a polymer, or by naming monomers it is derived from. In the present specification, a unit deriving from a monomer is understood as a unit that may be directly obtained from the said monomer by polymerizing. A part may be a copolymer, comprising several kind of repeating units, deriving form several monomers. Hence, part A and part B are different polymers, deriving from different monomers, but they may comprise some common repeating units (copolymers). Part A and part B preferably do not comprise more than 50% of a common repeating unit (derived from the same monomer).

Preferably, part A is polyionic (polyanionic or polycationic) in pH conditions of the formulation. That means that part A comprises ionic (anionic or cationic) repetitive units regardless of the pH, or that part A comprises repetitive units that may be neutral or ionic (anionic or cationic) depending on the pH of the formulation (the units are potentially ionic). A unit that may be neutral or ionic (anionic or cationic), depending on the pH of the composition, will be thereafter referred to as an ionic unit (anionic or cationic), or as a unit deriving from an ionic monomer (anionic or cationic), whenever it is in a neutral form or in an ionic form (anionic or cationic).

In a particular embodiment of the invention, part A is polycationic and comprises units derived from cationic monomers. Some preferred cationic monomers comprise an ammonium group of formula —NR₃⁺, wherein R, which is identical or different, represents a hydrogen atom, an alkyl group comprising 1 to 10 carbon atoms, or a benzyl group, optionally carrying a hydroxyl group, and may comprise an anion (counter-ion). Examples of anions are halides such as chloride and bromides, sulphates, hydrosulphates, alkylsulphates (for example comprising 1 to 6 carbon atoms), phosphates, citrates, formates, and acetates.

Examples of suitable cationic monomers include but are not limited to
aminoalkyl (meth)acrylates, aminoalkyl (meth)acrylamides,
monomers, including particularly (meth)acrylates, and (meth)acrylamides derivatives, comprising at least one secondary, tertiary or quaternary amine function, or a heterocyclic group containing a nitrogen atom, vinylamine or ethylenimine;
diallyidialkyl ammonium salts;
their mixtures, their salts, and macromonomers deriving from therefrom.

Specific examples of cationic monomers include:
dimethylaminoethyl (meth)acrylate, dimethylaminopropyl (meth)acrylate, ditertiobutylaminoethyl (meth)acrylate, dimethylaminomethyl (meth)acrylamide, dimethylaminopropyl (meth)acrylamide;
ethylenimine, vinylamine, 2-vinylpyridine, 4-vinylpyridine;
trimethylammonium ethyl (meth)acrylate chloride, trimethylammonium ethyl (meth)acrylate methyl sulphate, dimethylammonium ethyl (meth)acrylate benzyl chloride, 4-benzoylbenzyl dimethylammonium ethyl acrylate chloride, trimethyl ammonium ethyl (meth)acrylamido (also called 2-(acryloxy)ethyltrimethylammonium, TMAEAMS, or Padamquat) chloride, trimethylammonium ethyl (meth)acrylate (also called 2-(acryloxy)ethyltrimethylammonium, TMAEAMS, or Padamquat) methyl sulphate, trimethyl ammonium propyl (meth)acrylamido chloride, vinylbenzyl trimethyl ammonium chloride,
diallyldimethyl ammonium chloride,
monomers having the following formula:

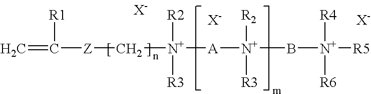

wherein

R₁ is a hydrogen atom or a methyl or ethyl group;

R₂, R₃, R₄, R₅ and R₆, which are identical or different, are linear or branched C₁-C₆, preferably C₁-C₄, alkyl, hydroxyalkyl or aminoalkyl groups;

m is an integer from 1 to 10, for example 1;

n is an integer from 1 to 6, preferably 2 to 4;

Z represents a —C(O)O— or —C(O)NH— group or an oxygen atom;

A represents a (CH₂)ₚ group, p being an integer from 1 to 6, preferably from 2 to 4;

B represents a linear or branched C₂-C₁₂, advantageously C₃-C₆, polymethylene chain optionally interrupted by one or more heteroatoms or heterogroups, in particular O or NH, and optionally substituted by one or more hydroxyl or amino groups, preferably hydroxyl groups;

X, which are identical or different, represent counter-ions, and

their mixtures, and macromonomers deriving therefrom.

In another embodiment of the invention, part A is polyanionic and comprises units deriving from anionic monomers.

Examples of suitable anionic parts, are parts comprising units derived from anionic monomers selected from the group consisting of:
alpha-ethylenically-unsaturated monomers comprising a phosphate or phosphonate group,
alpha-ethylenically-unsaturated monocarboxylic acids,
monoalkylesters of alpha-ethylenically-unsaturated dicarboxylic acids,
monoalkylamides of alpha-ethylenically-unsaturated dicarboxylic acids,
alpha-ethylenically-unsaturated compounds comprising a sulphonic acid group, and salts of alpha-ethylenically-unsaturated compounds comprising a sulphonic acid group.

Preferred anionic parts include, but are not limited to, parts derived from at least one anionic monomer selected from the group consisting of:
acrylic acid, methacrylic acid, salts of acrylic acid, salts of methacrylic acid,
vinyl sulphonic acid, salts of vinyl sulphonic acid,
vinylbenzene sulphonic acid, salts of vinylbenzene sulphonic acid,
alpha-acrylamidomethylpropanesulphonic acid, salts of alpha-acrylamidomethylpropanesulphonic acid
2-sulphoethyl methacrylate, salts of 2-sulphoethyl methacrylate,
acrylamido-2-methylpropanesulphonic acid (AMPS), salts of acrylamido-2-methylpropanesulphonic acid, and
styrenesulfonate (SS), and salts of SS.

Part B is preferably neutral in pH conditions of the formulation. Accordingly, units which make up part B are preferably neutral whatever the pH.

Examples of neutral parts are parts comprising units derived from at least one monomer selected from the group consisting of:
alkyl oxides, such as ethylene oxide, and propylene oxide,
acrylamide, methacrylamide,
amides of alpha-ethylenically-unsaturated, preferably mono-alpha-ethylenically-unsaturated, monocarboxylic acids,
esters of an alpha-ethylenically-unsaturated, preferably mono-alpha-ethylenically-unsaturated, monocarboxylic acid, for example alkyl esters such as such as methylacrylate, ethylacrylate, n-propylacrylate, n-butylacrylate, methylmethacrylate, ethylmethacrylate, n-propylmethacrylate, n-butylmethacrylate, 2-ethyl-hexyl acrylate, or hydroxyalkyl esters such as 2-hydroxyethylacrylate,
polyethylene and/or polypropylene oxide (meth)acrylates (i.e. polyethoxylated and/or polypropoxylated (meth)acrylic acid),
vinyl alcohol,
vinyl pyrrolidone,
vinyl acetate, vinyl versatate,
vinyl nitriles, preferably comprising from 3 to 12 carbon atoms,
acrylonitrile,
vinylamine amides,
vinyl aromatic compounds, such as styrene, and
   mixtures thereof.

Parts that are ionic in the pH conditions of the formulation are usually considered as water-soluble. Thus, part A is usually considered as water-soluble. In a preferred embodiment of the invention, part B is water-soluble, or hydrophilic. Water-solubility of a part refers to the water-solubility that said part would have without the other part(s) that is the water-solubility of a polymer consisting of the same repeating units than said part, having the same molecular weight. By water-soluble part, polymer or copolymer, it is meant that the part, polymer or copolymer does not phase separate macroscopically in water at a concentration from 0.01% and 10% by weight, at a temperature from 20° C. to 30° C. By hydrophilic, it is meant that the moiety does not phase separate macroscopically in water at a concentration of from 0.1% and 1% by weight, at a temperature of from 20° C. to 30° C. By hydrophobic, it is meant that the moiety does phase separate macroscopically in water at a concentration of from 0.1% and 1% by weight, at a temperature of from 20° C. to 30° C.

Advantageously, copolymer (a) is water-soluble, both part A and part B being hydrophilic and/or water-soluble. As mentioned above, part B may be discriminated as regard to its hydrophilic or hydrophobic properties.

Examples of neutral parts considered as hydrophilic include parts comprising units deriving from at least one monomer selected from the group consisting of:
ethylene oxide,
vinyl alcohol,
vinyl pyrrolidone,
acrylamide, methacrylamide,
polyethylene oxide (meth)acrylate (i.e. polyethoxylated (meth)acrylic acid),
hydroxyalkylesters of alpha-ethylenically-unsaturated, preferably mono-alpha-ethylenically-unsaturated, monocarboxylic acids, such as 2-hydroxyethylacrylate, and
hdyroxyalkylamides of alpha-ethylenically-unsaturated, preferably mono-alpha-ethylenically-unsaturated, monocarboxylic acids.

Examples of neutral parts considered as hydrophobic include parts comprising units deriving from at least one monomer selected from the group consisting of:
propylene oxide,
alkylesters of an alpha-ethylenically-unsaturated, preferably mono-alpha-ethylenically-unsaturated, monocarboxylic acid, such as methylacrylate, ethylacrylate, n-propylacrylate, n-butylacrylate, methylmethacrylate, ethylmethacrylate, n-propylmethacrylate, n-butylmethacrylate, and 2-ethyl-hexyl acrylate,
acrylonitrile
vinyl nitriles, comprising from 3 to 12 carbon atoms,
vinylamine amides, and
vinylaromatic compounds such as styrene.

Preferably, at least one part selected from the group consisting of part A and part B is derived from mono-alpha-ethylenically-unsaturated monomers. In a preferred embodiment, part A and part B are derived from mono-alpha-ethylenically-unsaturated monomers.

From the monomers mentioned above, mono-alpha-ethylenically-unsaturated monomers include:
dimethylaminoethyl (meth)acrylate, dimethylaminopropyl (meth)acrylate, ditertiobutylaminoethyl (meth)acrylate, dimethylaminomethyl (meth)acrylamide, dimethylaminopropyl (meth)acrylamide;
ethylenimine, vinylamine, 2-vinylpyridine, 4- vinylpyridine;
trimethylammonium ethyl (meth)acrylate (also called 2-(acryloxy)ethyltrimethylammonium, TMAEAMS, or Padamquat) chloride, trimethylammonium ethyl (meth)acrylate (also called 2-(acryloxy)ethyltrimethylammonium, TMAEAMS, or Padamquat) methyl sulphate, dimethylammonium ethyl (meth)acrylate benzyl chloride, 4-benzoylbenzyl dimethylammonium ethyl acrylate chloride, trimethyl ammonium ethyl (meth)acrylamido chloride, trimethyl ammonium propyl (meth)acrylamido chloride, vinylbenzyl trimethyl ammonium chloride,
diallyidimethyl ammonium chloride,
acrylic acid, methacrylic acid, salts of acrylic acid, salts of methacrylic acid,
vinyl sulphonic acid, salts of vinyl sulphonic acid,
vinylbenzene sulphonic acid, salts of vinylbenzene sulphonic acid,
alpha-acrylamidomethylpropanesulphonic acid, salts of alpha-acrylamidomethylpropanesulphonic acid
2-sulphoethyl methacrylate, salts of 2-sulphoethyl methacrylate,
acrylamido-2-methylpropanesulphonic acid (AMPS), salts of acrylamido-2-methylpropanesulphonic acid,
styrenesulfonate (SS), salts of SS,
vinyl acetate,
vinyl alcohol
vinyl pyrrolidone,
styrene,
acrylamide, methacrylamide,
acrylonitrile,
methylacrylate, ethylacrylate, n-propylacrylate, n-butylacrylate, methylmethacrylate, ethylmethacrylate, n-propylmethacrylate, n-butylmethacrylate, 2-ethyl-hexyl acrylate, and
2-hydroxyethylacrylate.

It is possible for example to use anionic polymerization with sequential addition of 2 monomers as described for example by Schmolka, J. Am. Oil Chem. Soc. 1977, 54, 110; or alternatively Wilczek-Veraet et al., Macromolecules 1996, 29, 4036. Another method which can be used consists in initiating the polymerization of a part polymer at each of the ends of another part polymer as described for example by Katayose and Kataoka, Proc. Intern. Symp. Control. Rel. Bioact. Materials, 1996, 23, 899.

In the context of the present invention, it is recommended to use living or controlled polymerization as defined by Quirk and Lee (Polymer International 27, 359 (1992)). Indeed, this particular method makes it possible to prepare polymers with a narrow dispersity and in which the length and the composition of the parts are controlled by the stoichiometry and the degree of conversion. In the context of this type of polymerization, there are more particularly recommended the copolymers which can be obtained by any so-called living or controlled polymerization method such as, for example:
free-radical polymerization controlled by xanthates according to the teaching of Application WO 98/58974 and Patent U.S. Pat. No. 6,153,705,
free-radical polymerization controlled by dithioesters according to the teaching of Application WO 98/01478,
free-radical polymerization controlled by dithioesters according to the teaching of Application WO 99/35178,
free-radical polymerization controlled by dithiocarbamates according to the teaching of Application WO 99/35177,
free-polymerization using nitroxide precursors according to the teaching of Application WO 99/03894,
free-radical polymerization controlled by dithiocarbamates according to the teaching of Application WO 99/31144,
free-radical polymerization controlled by dithiocarbazates according to the teaching of Application WO 02/26836,
free-radical polymerization controlled by halogenated Xanthates according to the teaching of Application WO 00/75207 and U.S. application Ser. No. 09/980,387,
free-radical polymerization controlled by dithiophosphoroesters according to the teaching of Application WO 02/10223,
free-radical polymerization controlled by a transfer agent in the presence of a disulphur compound according to the teaching of Application WO 02/22688,
atom transfer radical polymerization (ATRP) according to the teaching of Application WO 96/30421,
free-radical polymerization controlled by iniferters according to the teaching of Otu et al., Makromol. Chem. Rapid. Commun., 3, 127 (1982),
free-radical polymerization controlled by degenerative transfer of iodine according to the teaching of Tatemoto et al., Jap. 50, 127, 991 (1975), Daikin Kogyo Co Ltd Japan, and Matyjaszewski et al., Macromolecules, 28, 2093 (1995),
group transfer polymerization according to the teaching of Webster O. W., “Group Transfer Polymerization”, p. 580-588, in the “Encyclopedia of Polymer Science and Engineering”, Vol. 7, edited by H. F. Mark, N. M. Bikales, C. G. Overberger and G. Menges, Wiley Interscience, New York, 1987,
radical polymerization controlled by tetraphenylethane derivatives (D. Braun et al., Macromol. Symp., 111, 63 (1996)),
radical polymerization controlled by organocobalt complexes (Wayland et al., J. Am. Chem. Soc., 116, 7973 (1994)).

Preferred processes are sequenced living free-radical polymerization processes, involving the use of a transfer agent. Preferred transfer agents are agents comprising a group of formula —S—C(S)—Y—, —S—C(S)—S—, or —S—P(S)—Y—, or —S—P(S)—S—, wherein Y is an atom different from sulfur, such as an oxygen atom, a nitrogen atom, and a carbon atom. They include dithioester groups, thioether-thione groups, dithiocarbamate groups, dithiphosphoroesters, dithiocarbazates, and xanthate groups. Examples of preferred transfer agents include groups of formula —S—C(S)—NR—NR′₂, —S—C(S)—NR—N═CR′₂, —S—C(S)—O—R, —S—C(S)—CR═CR′₂, and —S—C(S)—X, wherein R and R′ are or identical or different hydrogen atoms, or organic groups such as hydrocarbyl groups, optionally substituted, optionally comprising heteroatoms, and X is an halogen atom. A preferred polymerization process is a living radical polymerization using xanthates.

Copolymers obtained by a living or controlled free-radical polymerization process may comprise at least one transfer agent group at an end of the polymer chain. In particular embodiment such a group is removed or deactivated. A “living” or “controlled” radical polymerization process used to make the part copolymers comprises the steps of:

a) reacting a mono-alpha-ethylenically-unsaturated monomer, at least a free radicals source compound, and a transfer agent, to obtain a first part, the transfer agent being bounded to said first part,

b1) reacting the first part, another mono-alpha-ethylenically-unsaturated monomer, and, optionally, at least a radical source compound, to obtain a di-part copolymer,

b2) optionally, repeating n times (n being equal to or greater than 0) step b1) to obtain a (n-2)-part copolymer, and then

c) optionally, reacting the transfer agent with means to render it inactive.

Examples of transfer agents are transfer agents of the following formula (I): 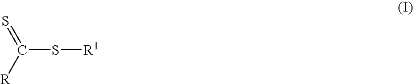
wherein:
R represents an R²O—, R²R′²N— or R³— group, R² and R′², which are identical or different, representing (i) an alkyl, acyl, aryl, alkene or alkyne group or (ii) an optionally aromatic, saturated or unsaturated carbonaceous ring or (iii) a saturated or unsaturated heterocycle, it being possible for these groups and rings (i), (ii) and (iii) to be substituted, R³ representing H, Cl, an alkyl, aryl, alkene or alkyne group, an optionally substituted, saturated or unsaturated (hetero)cycle, an alkylthio, alkoxycarbonyl, aryloxycarbonyl, carboxyl, acyloxy, carbamoyl, cyano, dialkyl- or diarylphosphonato, or dialkyl- or diarylphosphinato group, or a polymer chain,
R¹ represents (i) an optionally substituted alkyl, acyl, aryl, alkene or alkyne group or (ii) a carbon containing ring which is saturated or unsaturated and which is optionally substituted or aromatic or (iii) an optionally substituted, saturated or unsaturated heterocycle or a polymer chain, and the R¹, R², R² and R³ groups can be substituted by substituted phenyl or alkyl groups, substituted aromatic groups or the following groups: oxo, alkoxycarbonyl or aryloxycarbonyl (—COOR), carboxyl (—COOH), acyloxy (—O₂CR), carbamoyl (—CONR₂), cyano (—CN), alkylcarbonyl, alkylarylcarbonyl, arylcarbonyl, arylalkylcarbonyl, isocyanato, phthalimido, maleimido, succinimido, amidino, guanidino, hydroxyl (—OH), amino (—NR₂), halogen, allyl, epoxy, alkoxy (—OR), S-alkyl; S-aryl or silyl, groups exhibiting a hydrophilic or ionic nature, such as alkaline salts of carboxylic acids or alkaline salts of sulphonic acid, poly(alkylene oxide) (PEO, PPO) chains, or cationic substituents (quaternary ammonium salts), R representing an alkyl or aryl group.

Preferably, the transfer agent of formula (I) is a dithiocarbonate chosen from the compounds of following formulae (IA), (IB) and (IC): 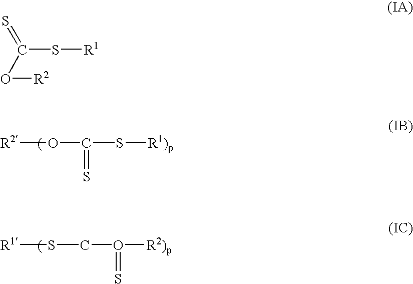
wherein:
R² and R²′ represent (i) an alkyl, acyl, aryl, alkene or alkyne group or (ii) an optionally aromatic, saturated or unsaturated carbonaceous ring or (iii) a saturated or unsaturated heterocycle, it being possible for these groups and rings (i), (ii) and (iii) to be substituted,
R′ and R¹′ represent (i) an optionally substituted alkyl, acyl, aryl, alkene or alkyne group or (ii) a carbonaceous ring which is saturated or unsaturated and which is optionally substituted or aromatic or (iii) an optionally substituted, saturated or unsaturated heterocycle or a polymer chain, and
p is between 2 and 10.

Other examples of transfer agents are transfer agents of the following formulae (II) and (III): 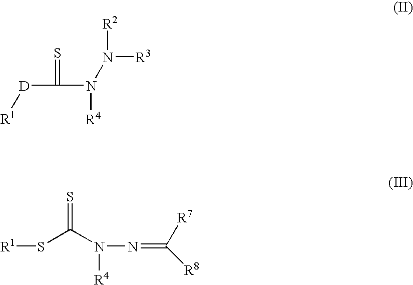
wherein

R¹ is an organic group, for example a group R¹ as defined above for transfer agents of formulae (I), (IA), (IB), and (IC),

R², R³, R⁴, R⁷, and R⁸ which are identical or different are hydrogen atoms or organic groups, optionally forming rings. Examples of R², R³, R⁴, R⁷, and R⁸ organic groups include hydrocarbyls, substituted hydrocarbyls, heteroatom-containing hydrocarbyls, and substituted heteroatom-containing hydrocarbyls.

The mono-alpha-ethylenically-unsaturated monomers and their proportions are chosen in order to obtain the desired properties for the part(s). According to this process, if all the successive polymerizations are carried out in the same reactor, it is generally preferable for all the monomers used during one stage to have been consumed before the polymerization of the following stage begins, therefore before the new monomers are introduced. However, it may happen that monomers of the preceding stage are still present in the reactor during the polymerization of the following part. In this case, these monomers generally do not represent more than 5 mol % of all the monomers.

The polymerization can be carried out in an aqueous and/or organic solvent medium. The polymerization can also be carried out in a substantially neat melted form (bulk polymerization), or according to a latex type process in an aqueous medium.

The molecularweight of copolymer (a) is preferably comprised between 1000 and 500000 g/mol. It is more preferably less than 100000 g/mol, and further more preferably between 15000 and 20000 g/mol. Within these ranges, the weight ratio of each part may vary. It is however preferred that each part have a molecular weight above 500 g/mol, and preferably above 1000 g/mol.

As discussed above, in another embodiment the copolymer of the present invention comprises a comb copolymer that comprises randomly distributed or alternating cationic units and nonionic units.

In one embodiment, the comb copolymer according to the present invention comprises one or more segments comprising randomly distributed cationic monomeric units according to formula (II) and nonionic monomeric units according to formula (IV), as illustrated by formula (VI): 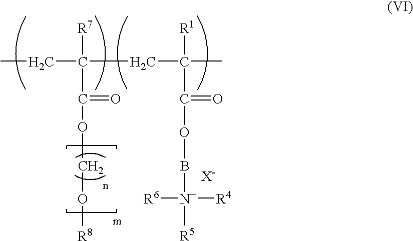
wherein:

R1, R4, R5, R6, R7, R8, X—, n, and m are each defined as above.

In one embodiment, random comb copolymers according to the present invention are made by known free radical polymerization processes using ethylenically unsaturated monomers or by graft polymerization wherein cationic substituent groups and/or nonionic substituent groups are added at reactive sites on a polymer backbone.

In another embodiment, alternating comb copolymers according to the present invention are made by polycondensation, such as, for example, according to scheme (A): 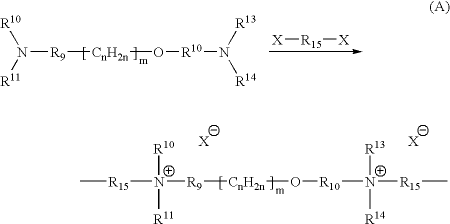
wherein R9, R10, R11, R12, R13, R14, and R15 are each hydrocarbon groups which may optionally contain one or more heteroatoms, more typically, (C1-C6)alkyl, or (C1-C6)alkenyl.

In a particular embodiment of the invention, the composition comprises a surfactant (b). Surfactant (b) is preferably an ionic (cationic or anionic) surfactant, in pH conditions of the composition.

In some embodiments:

if surfactant (b) is an anionic surfactant in the pH condition of the composition, then part A is a cationic part in the pH conditions of the composition (i.e. surfactant and part A have opposite charges), or

if surfactant (b) is a cationic surfactant in the pH conditions of the composition, then part A is a polyanionic part in the pH conditions of the composition (i.e. surfactant and part A have opposite charges).

When surfactant (b) and copolymer (a) have opposite charges, they form a complex, preferably dispersed in water in the composition. In a preferred embodiment, the surfactant is an anionic surfactant in the pH conditions of the composition, part A is a polycationic part in the pH conditions of the composition, and part B is a hydrophilic water-soluble part.

Examples of cationic surfactants (b) include the following compounds:
primary, secondary or tertiary mono- or polyamines, or those possessing one or more quaternary ammonium groups, more particularly comprising 6 to 40 carbon atoms linear or branched aliphatic, aromatic, as well as those optionally comprising one or more alcoxylated ethoxylated and/or propoxylated groups. There may be cited as examples, hexylamine, octylamine, dodecylamine, stearylamine, hexadecylamine, oleylamine, diaminohexane, diaminoheptane, diaminododecane, benzoctamine, alkyldialkylammonium or alkyltrialkylammonium or alkylbenzyldialkylammonium halides, such as chloride, dodecyltrimethyl-ammonium bromide, chloride, hexadecyltrimethylammonium bromide, chloride, benzalkonium bromide;
piperidinium salts,
imidazoles,
heterocyclic amines, and
mixture thereof.

Examples of anionic surfactants (b) include the following compounds:
alkyl ester sulphonates, alkylbenzene sulphonates, primary or secondary alkylsulphonates, alkylglycerol sulphonates, sulphonated polycarboxylic acids.
alkylsulphates, sulphates of alkylglycosides, sulphated alkyl amides,
alkylphosphates,
the salts of saturated or unsaturated fatty acids, paraffin sulphonates, N-acyl N-alkyltaurates, isethionates, alkylsuccinamates, N-acyl sarcosinates,
alkylsulfosuccinates, monoesters or diesters of sulfosuccinates,
polyethoxycarboxylates.

As more precise examples of such surfactants the following can be mentioned:
—Alkylester sulphonates of formula R—CH(SO₃M)—COOR′, where R represents an alkyl radical in C₈-C₂₀, preferably in C₁₀-C₁₆. R′ an alkyl radical in C₁-C₆, preferably in C₁-C₃ and M an alkaline cation (sodium, potassium, lithium), substituted or non-substituted ammonium (methyl-, dimethyl-, trimethyl-, tetramethylammonium, dimethylpiperidinium . . . ) or alcanolamine derivative (monoethanolamine, diethanolamine, triethanolamine . . . ). The methyl ester sulphonates, the R radical of which is in C₁₄-C₁₆, can quite particularly be mentioned:
the alkylsulphates of formula ROSO₃M, where R represents an alkyl or hydroxyalkyl radical in C₅-C₂₄, preferably in C₁₀-C₁₈, M representing a hydrogen atom or a cation with the same definition as above, as well as their ethoxylated (EO) and/or propoxylated (PO) derivatives, on average having from 0.5 to 30 units, preferably from 0.5 to 10 EO and/or PO units;
the sulphated alkylamides of formula RCONHR′OSO₃M where R represents an alkyl radical in C₂-C₂₂, preferably in C₆-C₂₀, R′ an alkyl radical in C₂-C₃, M representing a hydrogen atom or a cation of the same definition as above, as well as their ethoxylated (EO) and/or propoxylated (PO) derivatives, having on average from 0.5 to 60 EO and/or PO units;
the salts of saturated or unsaturated fatty acids in C₈-C₂₄, preferably in C₁₄-C₂₀, alkylbenzenesulphonates in C₉-C₂₀, primary or secondary alkylsulphonates in C₈-C₂₂, alkylglycerol sulphonates, sulphonated polycarboxylic acids, paraffin sulphonates, N-acyl N-alkyltaurates, alkylphosphates, isethionates, alkylsuccinamates, alkylsulfosuccinates, the monoesters or diesters, of N-acyl sulfosuccinate sarcosinates, the sulphates of alkylglycosides, polyethoxycarboxylates; the cation being an alkali metal (sodium, potassium, lithium), a substituted or non-substituted ammonium residue (methyl-, dimethyl-, trimethyl-, tetramethylammonium, dimethylpiperidinium . . . ) or alcanolamine derivative (monoethanolamine, diethanolamine, triethanolamine . . . ).

In some embodiments of the invention, the composition further comprises a polyionic polymer (c).

Preferably, polymer (c) is a polycationic polymer in the pH condition of the composition, if part A is a polyanionic part in the pH conditions of the composition, or polymer (c) is a polyanionic polymer in the pH conditions of the composition, if part A is a polycationic part in the pH conditions of the composition.

In certain embodiments, the composition may comprise surfactant (b) and a polyanionic polymer (c), whereby surfactant (b) is an anionic surfactant in the pH condition of the composition, and polymer (c) is a polyanionic polymer in the pH condition of the composition, if part A is a polycationic part in the pH conditions of the composition, or surfactant (b) is a cationic surfactant in the pH conditions of the composition, and polymer (c) is a polycationic polymer in the pH condition of the composition if part A is a polyanionic part in the pH conditions of the composition.

Copolymer (a), surfactant (b), and polymer (c) may form a complex. For example a complex in accordance with the invention may comprise a surfactant (b) being anionic in the pH condition of the composition, a polymer (c) being polyanionic in the pH condition of the composition, and a copolymer (a) wherein part A is a polycationic part in the pH conditions of the composition.

Examples of polycationic polymer (c) include hydroxyalkylated (C₂-C₂₂) derivatives of cationic guars such as hydroxypropyl guar hydroxypropyl trimonium chlorite (JAGUAR C162 and JAGUAR C2000 sold by Rhodia) and cationic cellulose derivatives, in particular cellulose,2-(2-hydroxy-3-(trimethylammonium)propoxy)ethyl ether, chloride or polyquaternium-10 (polymer JR400 sold by Union Carbide). The cationic nature of these polymers is variable: thus in the case of cationic hydroxypropylated guar derivatives such as JAGUAR C162 and C2000 sold by Rhodia, the degree of hydroxypropylation (molar substitution, MS), is in the range 0.02 to 1.2 and the degree of substitution, DS is in the range 0.01 to 0.6. These products can optionally be functionalized by hydrophobic groups such as alkyl chains. These cationic polymers can optionally be functionalized by anionic groups such as carboxymethyl, sulphate, sulphonate or phosphate, provided that the degree of substitution of these anionic groups is always less than the degree of substitution of the cationic groups. The molecular weight of these cationic polymers is generally at least 2000, more generally of the order of 200,000 to 3,000,000.

Examples of cationic polymers (c) also include polymers comprising units deriving from monomers selected from the group consisting of:
dimethylaminoethyl (meth)acrylate, dimethylaminopropyl (meth)acrylate, ditertiobutylaminoethyl (meth)acrylate, dimethylaminomethyl (meth)acrylamide, dimethylaminopropyl (meth)acrylamide;
ethylenimine, vinylamine, 2-vinylpyridine, 4- vinylpyridine;
trimethylammonium ethyl (meth)acrylate (also called 2-(acryloxy)ethyltrimethylammonium, TMAEAMS, or Padamquat) chloride, trimethylammonium ethyl (meth)acrylate (also called 2-(acryloxy)ethyltrimethylammonium, TMAEAMS, or Padamquat) methyl sulphate, dimethylammonium ethyl (meth)acrylate benzyl chloride, 4-benzoylbenzyl dimethylammonium ethyl acrylate chloride, trimethyl ammonium ethyl (meth)acrylamido chloride, trimethyl ammonium propyl (meth)acrylamido chloride, vinylbenzyl trimethyl ammonium chloride,
diallyldimethyl ammonium chloride,
monomers having the following formula:

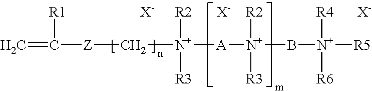

wherein

R₁ is a hydrogen atom or a methyl or ethyl group;

R₂, R₃, R₄, R₅ and R₆, which are identical or different, are linear or branched C₁-C₆, preferably C₁-C₄, alkyl, hydroxyalkyl or aminoalkyl groups;

m is an integer from 1 to 10, for example 1;

n is an integer from 1 to 6, preferably 2 to 4;

Z represents a —C(O)O— or —C(O)NH— group or an oxygen atom;

A represents a (CH₂)p group, p being an integer from 1 to 6, preferably from 2 to 4;

B represents a linear or branched C₂-C₁₂, advantageously C₃-C₆, polymethylene chain optionally interrupted by one or more heteroatoms or heterogroups, in particular O or NH, and optionally substituted by one or more hydroxyl or amino groups, preferably hydroxyl groups;

X⁻, which are identical or different, represent counter-ions, and

their mixtures, and macromonomers deriving therefrom.

Examples of anionic polymers (c) include polymers comprising units deriving from monomers selected from the group consisting of:
alpha-ethylenically-unsaturated monocarboxylic acids, such as acrylic acid and methacrylic acid, salts of acrylic acid, salts of methacrylic acid,
monoalkylesters of alpha-ethylenically-unsaturated dicarboxylic acids, preferably monoalkylesters of mono-alpha-ethylenically-unsaturated dicarboxylic acids,
monoalkylamides of alpha-ethylenically-unsaturated dicarboxylic acids, preferably monoalkylamides of mono-alpha-ethylenically unsaturated dicarboxylic acids,
alpha-ethylenically-unsaturated, preferably mono-alpha-ethylenically-unsaturated, compounds comprising a sulfonic acid group, and salts thereof, such as:

vinyl sulfonic acid, salts of vinyl sulfonic acid,

vinylbenzene sulfonic acid, salts of vinylbenzene sulfonic acid,

alpha-acrylamidomethylpropanesulfonic acid, salts of alpha-acrylamidomethylpropanesulfonic acid

2-sulfoethyl methacrylate, salts of 2-sulfoethyl methacrylate,

acrylamido-2-methylpropanesulfonic acid (AMPS), salts of acrylamido-2-methylpropanesulfonic acid,

styrenesulphonate (SS), salts of SS,
alpha-ethylenically-unsaturated monomers comprising a phosphate or phosphonate group, and salts thereof, and
   their mixtures, their salts, and macromonomers deriving from therefrom.

Compositions in accordance with the invention may comprise further compounds dependent on their intended application. Below are some compositions for various applications in accordance with the invention.

The process and composition according are useful for treating glass panels. This treatment can be carried out by means of the various known techniques. Mention may be made in particular of the techniques for cleaning glass panels by spraying them with a jet of water using machines of Karcher® type.

The amount of part copolymer introduced will generally be such that, during the use of the composition, after optional dilution, the concentration is between 0.001 g/l and 2 g/l, preferably from 0.005 g/l to 0.5 g/l.

A composition for treating glass panels according to the invention comprises:
from 0.001% to 10% and preferably from 0.005% to 3% by weight of at least one coacervate complex as defined above;
from 0.005% to 20% and preferably from 0.5% to 10% by weight of at least one nonionic (for example an amine oxide) and/or anionic surfactant; and
the remainder being formed of water and/or various additives that are common in the field.

The composition for glass panels comprising said coacervate complex can also contain:
from 0% to 10% and advantageously from 0.5% to 5% of amphoteric surfactant,
from 0% to 30% and advantageously from 0.5% to 15% of solvent such as alcohols, and
   the remainder consisting of water and common additives (in particular fragrances).

The process and composition according are useful for treating body parts of motor vehicles.

The cleaning composition for body parts of motor vehicles advantageously comprises from 0.05% to 5% by weight of the coacervate complex according to the invention relative to the total weight of said composition, as well as:
nonionic surfactants (in a proportion of from 0% to 30% and preferably from 0.5% to 15% of the formulation),
amphoteric and/or zwitterionic surfactants (in a proportion of from 0% to 30% and preferably from 0.5% to 15% of the formulation)
cationic surfactants (in a proportion of from 0% to 30% and preferably from 0.5% to 15% of the formulation);
anionic surfactants (in a proportion of from 0% to 30% and preferably from 0.5% to 15% of the formulation);
organic or inorganic detergent adjuvants (“builders”);
hydrotropic agents;
fillers, pH regulators, etc.

The minimum amount of surfactant present in this type of composition can be at least 1% of the formulation.

The process and composition according are useful for treating ceramics (tiles, baths, sinks, etc.).

In this case, the composition advantageously comprises from 0.02% to 5% by weight of coacervate complex relative to the total weight of said composition, as well as at least one surfactant.

Surfactants that are preferred are nonionic surfactants, in particular the compounds produced by condensation of alkylene oxide groups as described above which are of hydrophilic nature with a hydrophobic organic compound which may be of aliphatic or alkyl aromatic nature.

The length of the hydrophilic chain or of the polyoxyalkylene radical condensed with any hydrophobic group may easily be adjusted to obtain a water-soluble compound which has the desired degree of hydrophilic/hydrophobic balance (HLB).

The amount of nonionic surfactants in the composition of the invention is generally from 0% to 30% by weight and preferably from 0% to 20% by weight.

An anionic surfactant may optionally be present in an amount of from 0% to 30% and advantageously 0% to 20% by weight.

It is also possible, but not obligatory, to add amphoteric, cationic or zwitterionic detergents to the composition of the present invention for cleaning hard surfaces.

The total amount of surfactant compounds used in this type of composition is generally between 1.5% and 50% and preferably between 5% and 30% by weight, and more particularly between 10% and 20% by weight, relative to the total weight of the composition.

One composition which is particularly suitable for this purpose comprises from 0.05% to 5% coacervate complex by weight according to the invention.

The process and composition according to the invention are useful for cleaning toilets according to the invention also comprises an acidic cleaning agent which can consist of an inorganic acid such as phosphoric acid, sulfamic acid, hydrochloric acid, hydrofluoric acid, sulfuric acid, nitric acid or chromic acid and mixtures thereof, or an organic acid, in particular acetic acid, hydroxyacetic acid, adipic acid, citric acid, formic acid, fumaric acid, gluconic acid, glutaric acid, glycolic acid, malic acid, maleic acid, lactic acid, malonic acid, oxalic acid, succinic acid and tartaric acid, as well as mixtures thereof, and acid salts such as sodium bisulfate, and mixtures thereof.

In this case, the composition advantageously comprises from 0.02% to 5% by weight of coacervate complex relative to the total weight of said composition.

The amount of acidic ingredients is preferably between 0.1% and about 40% and more preferably between 0.5% and about 15% by weight relative to the total weight of the composition.

The preferred amount depends on the type of acidic cleaning agent used: for example, with sulfamic acid it is between about 0.2% and about 1%, with hydrochloric acid it is between about 1% and about 5%, with citric acid it is between about 2% and about 10%, with formic acid it is between about 5% and about 15%, and with phosphoric acid it is between about 5% and about 30% by weight.

The amount of acidic agent is generally such that the final pH of the composition is from about 0.5 to about 4, preferably 1 to 3.

The composition for toilet may also comprise from 0.5% to 10% by weight of a surfactant so as to contribute toward removing soiling or so as to give foaming or wetting properties or alternatively to enhance the cleaning efficacy of the composition. The surfactant is preferably an anionic or nonionic surfactant.

Cationic surfactants can also be added to the composition for cleaning toilet pans according to the invention, in order to provide germicidal properties. A person skilled in the art will see that amphoteric surfactants can also be used. Mixtures of various surfactants can be used, if so desired.

The composition for cleaning toilet pans according to the invention can also comprise a thickener such as a gum, in particular a xanthan gum introduced at a concentration of from 0.1% to 3%, as well as one or more of the following minor ingredients: a preserving agent intended to prevent the growth of microorganisms in the product, a dye, a fragrance and/or an abrasive agent.

The process and composition according to the invention are useful for treating walls of showers (for rinsing them).

The aqueous compositions for the walls of showers comprise from 0.02% to 5% by weight and advantageously from 0.05% to 1% of the coacervate complex of the invention.

The other main active components of the aqueous compositions for rinsing showers of the present invention are at least one surfactant present in an amount ranging from 0.5% to 5% by weight and optionally a metal-chelating agent present in an amount ranging from 0.01% to 5% by weight.

The preferred metal-chelating agents are ethylenediaminetetraacetic acid (EDTA) and its analogues.

The aqueous compositions for rinsing showers contain water, optionally with at least one lower alcohol in a majority proportion and additives in a minority proportion (between about 0.1% and about 5% by weight, more advantageously between about 0.5% and about 3% by weight and even more preferably between about 1% and about 2% by weight).

Certain surfactants which can be used in this type of application are described in U.S. Pat. Nos. 5,536,452 and 5,587,022, the content of which is incorporated by reference in the present description.

Preferred surfactants are polyethoxylated fatty esters, for example polyethoxylated sorbitan monooleates and polyethoxylated castor oil. Specific examples of such surfactants are the products of condensation of 20 mol of ethylene oxide and of sorbitan monooleate (sold by Rhodia Inc. under the name Alkamuls PSMO 20□ with an HLB of 15.0) and 30 mol or 40 mol of ethylene oxide and of castor oil (sold by Rhodia Inc. under the name Alkamuls EL 620® (HLB of 12.0) and EL 719® (HLB of 13.6), respectively). The degree of ethoxylation is preferably sufficient to obtain a surfactant with an HLB of greater than 13. Other surfactants such as alkylpolyglucosides are also suitable for these compositions.

Some illustrative but non-limiting examples are provided hereunder for the better understanding of the invention.

### EXAMPLE SYSTEMS AND PREPARATION

The following are example systems in which coacervates are formed and anti-adhesion and anti-deposition of soil are observed: diblocks of Padamquat-b-PAM (also known as TMAEAMS-b-PAM) (Poly(trimethylammonium ethyl acrylate methyl sulfate)-b-PolyAcrylamide) or random copolymers of Poly(trimethylammonium propyl methacrylamide chloride-co-methoxy polyethylene glycol 2000 monomethacrylate) (referred to as Maptac-co-PEG2000 MA) mixed at any pH with one of the following anionic surfactants or polyelectrolytes at Z>Z_{c}: sodium dodecyl sulfate (SDS), sodium dedecylbenzene sulfonate (LABS), poly(acrylic acid) at pH>9, or poly(styrene sodium sulfonate). Where the critical molar charge ratio (Z_{c}) forming complexes is equal to 0.1, and the preferred Z value is at its isoelectric conditions (Z=1). As the coacervates are unaffected by the addition of charged surfactants above Z=1, Z has no upper limit, and has been successfully demonstrated at values as high as 10.

Both copolymers (Padamquat-b-PAM and Maptac-co-PEG2000 MA) are Rhodia developmental products designated R0522-98 and 04ACU120. SDS was 99% active from Fluka (Fluka # 71728). LABS was Rhodia's Rhodacal LDS-22 (22.6% active) (Lot # BA4E016486). Sodium salt of PAA Mw 30,000 and 40% active was purchased from Aldrich (catalog # 41,604-5).

System 1: 2 wt % Padamquat-b-PAM (11k-30k) with SDS at Z=1 at pH 2.3.

Preparation: For a 50 gram sample at Z=1 and 2 wt % coacervates with both copolymer (freeze-dried) and surfactant being 100% active, 0.224 g SDS and 0.776 g copolymer were added to 49 g of deionized water while mixing. The Z equation takes the form: Z=[molar concentration SDS]/(41[molar concentration copolymer]).

System 2: 2 wt % Maptac-co-PEG2000 MA (ratio of Maptac to PEG is 80/20 with a mzolecular weight of 25,000) with LABS at Z=1 at pH 2.3.

Preparation: For a 50 gram sample at Z=1 and 2 wt % coacervates with copolymer (freeze-dried) at 100% active and surfactant being 22.6% active, 1.442 g LABS and 0.674 g copolymer were added to 47.884 g of deionized water while mixing. The Z equation takes the form: Z=[molar concentration LABS]/(32[molar concentration copolymer]). System 3: 2 wt % Padamquat-b-PAM (11k-30k) with poly(acrylic acid) (Mw 30k) at Z=1 at pH 9.

Preparation: For a 50 gram sample at Z=1 and 2 wt % coacervates with copolymer (freeze-dried) at 100% active and homopolymer PAA (hPAA) being 37% active, 0.189 g h-PAA and 0.930 g copolymer were added to 48.882 g of deionized water while mixing. Note that at pH 9, PAA is only 95% charged, and requires additional PAA to reach Z=1. The Z equation takes the form: Z=(396[molar concentration PAA])/(41[molar concentration copolymer]). The addition of 396 in the numerator stems from a 30K h-PAA chain with acrylic acid having a Mw of 72 g/mol has 417 monomer units. At pH 9, 95% of these units are negatively charged.

Systems 1, 2, and 3 were diluted to concentrations ranging between 200 ppm and 1 wt % through the addition of a 2 wt % solution of a nonionic APG surfactant (alkyl polyglucoside), glycolic acid, and or water. Final APG concentrations were always 1 wt % and pH was kept at 2.3 or 9, respectfully.

### Test Methods

Soap Scum Test with Rinse

The primary test was a soap scum rinse test in which black ceramic tiles were cleaned with ethanol and divided in half. One half was treated with a 1 wt % solution of APG at pH 2.3 (contains 2% glycolic acid) and the other with one of the above coacervate/APG mixtures. Treatment application consisted of 5 drops pipetted onto the tile surface and then spread with a KIMWIPE® commercially available from Kimberly-Clark Corporation. The tiles were then allowed to dry horizontally for 1 minute before being rinsed for 5 seconds with tap water at a flow rate of 4.5L/min. After drying vertically for another 15 minutes, the tiles were then treated with 5 drops of a model soap scum consisting by weight of 4.6% IVORY soap® commercially available from Procter & Gamble Co., 1.8% MgCl₂, 30.5% water, and 63.3% ethanol. After drying horizontally for 30 minutes, a thin white film would form on the surface of both halves of the tile. The tile then received its final tap water rinse at a flow rate of 7.5 L/min for 1.5 minutes.

### Results

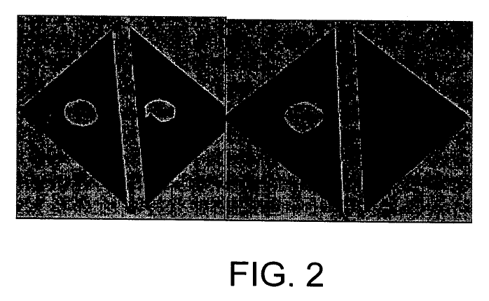

Following the final rinse, the side treated only with the APG solution remained unaffected where as the side treated with the coacervate/APG solutions generally rinsed clean within 30 seconds with minimal residual soap scum. Additionally, the rinsing off of the soil generally consisted of whole sheets of soil lifting away. Before and after photos of a black ceramic tile treated with the model soap scum are shown in FIG. 2. The left side of the tile was pretreated with a 1% solution of APG at pH 2.3 and the right was pretreated with a solution comprising 1% Padamquat-b-PAM (11k-30K)+SDS coacervates, 1% APG, 2% glycolic acid, and the remainder was water (final pH 2.3).

General results from the soap scum test on ceramic tiles were quite good for both the diblocks and comb polymers which behaved almost identically. The effect of changing the anionic surfactant/polyelectrolyte also produced similar results with only small changes in the amount of time necessary for the soil to rinse away. Usually, samples with LABS performed the best, SDS and PAA @ pH 9 were about the same, and samples with poly (sodium styrene sulfonate) were the slowest.

In addition to investigating the effect of changing the anionic surfactantpolyelectrolyte, the charge ratio, Z, was also investigated. As discussed above, Z is the stoichiometric ratio of charges of the anionic surfactant/polyelectrolyte to the cationic/neutral diblock or comb copolymer. It was decided to study Z=10. To do this two experiments were conducted: (A) keep the amount of the active polymer constant and change the total level of active and the amount of surfactant and (B) keep the total level of active constant and change the amount of polymer and surfactant. Both experiments resulted in no significant effect over the base system (complexes at Z=1), as reported in Table I.

TABLE I

| Polymer | Results (Soap Scum Removal on Ceramic) |
|---|---|
| System 1 | 100% removal in 15 seconds. No residue. |
| 1% Padamquat-PAM (11k-30k) + SDS at Z = 1 | |
| 1% APG 325 N; 2% Glycolic acid; pH 2.3 | |
| System 2 | 100% removalt in 30 seconds. slight residue. |
| 1% Maptac-co-PEG2000 MA (80:20) + LA BS at Z = 1 | |
| 1% APG 325 N; 2% Glycolic acid; pH 2.3 | |
| System 3 | 100% removal in 20 seconds. Slight residue. |
| 1% Padamquat-PAM (11k-30k) + PAA (30K) at Z = 1 | |
| 1% APG 325 N; 2% Glycolic acid; pH 9 | |
| System 1 with Z = 10 | 100% removal in 30 seconds. Slight residue. |
| 1% Padamquat-PAM (11k-30k) + SDS at Z = 10 | |
| 1% APG 325 N; 2% Glycolic acid; pH 2.3 | |

While the invention has been described and illustrated in detail herein, various alternative embodiments should become reality apparent to those skilled in this art without departing from the spirit and scope of the invention.

What is claimed is:

1. A hard surface cleaning composition comprising a coacervate complex having a molar charge ratio Z greater than 0.1, wherein said coacervate complex comprises a copolymer and at least one of two components selected from a surfactant or a polymer, whereby the copolymer is cationic if the polymer, surfactant, or combination of polymer and surfactant is anionic, or the copolymer is anionic if the polymer, surfactant, or combination of polymer and surfactant is cationic.

2. The composition of claim 1 wherein said copolymer comprises at least two parts, A and B, part A being polyionic and part B being neutral in pH conditions of said composition.

3. The composition of claim 2 wherein at least one of part A and part B is derived from mono-alpha-ethylenically-unsaturated monomers.

4. The composition of claim 3 wherein at least 50% of the repeating units of part A or part B, are mono-alpha-ethylenically-unsaturated monomers derived units.

5. The composition of claim 1 comprising from about 0.001% to about 10% by weight of said coacervate complex.

6. The composition of claim 1 wherein said coacervate complex comprises diblocks of Padamquat-b-PAM (Poly(trimethylammonium ethyl acrylate methyl sulfate)-b-PolyAcrylamide) or copolymers of Poly(trimethylammonium propyl methacrylamide chloride-co-methoxy polyethylene glycol monomethacrylate).

7. The composition of claim 6 further comprising an anionic surfactant selected from the group consisting of sodium dodecyl sulfate or sodium dedecylbenzene sulfonate.

8. The composition of claim 6 further comprising a polyelectrolytes selected from the group consisting of poly(acrylic acid) (only when the composition pH>9), or poly(styrene sodium sulfonate).

9. The composition of claim 1 comprising a coacervate complex having a molar charge ratio greater than 0. 1, said complex being present in an effective amount to provide anti-deposition properties to the hard surface.

10. The composition of claim 9 wherein said coacervate complex comprises a copolymer and at least one of two components selected from a surfactant or a polymer, whereby the copolymer is cationic if the polymer, surfactant, or combination of polymer and surfactant is anionic, or the copolymer is anionic if the polymer, surfactant, or combination of polymer and surfactant is cationic.

11. The composition of claim 1 comprising a coacervate complex having a charge ratio Z greater than 0.1, in an effective amount to provide anti-adhesion properties to the hard surface.

12. The composition of claim 11 wherein said coacervate complex comprises a copolymer and at least one of two components selected from a surfactant or a polymer, whereby the copolymer is cationic if the polymer, surfactant, or combination of polymer and surfactant is anionic, or the copolymer is anionic if the polymer, surfactant, or combination of polymer and surfactant is cationic.

13. The composition of claim 1 formulated for pre-treating a hard surface.

14. The composition of claim 13 wherein said coacervate complex is present in an amount of from about 0.001% to 10% by weight of the composition.

15. The composition of claim 13 wherein said coacervate complex comprises diblocks of Padamquat-b-PAM (Poly(trimethylammonium ethyl acrylate methyl sulfate)-b-PolyAcrylamide) or copolymers of Poly(trimethylammonium propyl methacrylamide chloride-co-methoxy polyethylene glycol monomethacrylate).

16. The composition of claim 13 further comprising an anionic surfactant selected from the group consisting of sodium dodecyl sulfate or sodium dedecylbenzene sulfonate.

17. The composition of claim 13 further comprising a polyelectrolytes selected from the group consisting of poly(acrylic acid) (only when the composition pH>9), or poly(styrene sodium sulfonate).

18. The composition of claim 1 useful for treating glass panels and comprising from about 0.01% to about 10% by weight of a coacervate complex having a molar charge ratio greater than 0.1 and from about 0.005% to about 20% by weight of at least surfactant selected from the group consisting of nonionic surfactant, anionic surfactant, or combinations thereof.

19. The composition of claim 18 further comprising from about 0% to about 10% by weight of an amphoteric surfactant and from about 0% to about 30% of solvent.

20. The composition of claim 1 useful for cleaning motor vehicle body parts and comprising from about 0.05% to about 5% by weight of a coacervate complex having a molar charge ratio greater than 0.1.

21. The composition of claim 20 further comprising at least about 1% surfactants selected from the group consisting of from about 0% to about 30% by weight nonionic surfactants; from about 0% to 30% by weight amphoteric surfactants, zwitterionic surfactants, or combinations thereof; from about 0% to 30% by weight cationic surfactants; 0% to 30% by weight anionic surfactants and combinations thereof;

22. The composition of claim 21 further comprising organic or inorganic detergent adjuvants, hydrotropic agents, fillers, pH regulators, or combinations thereof.

23. The composition of claim 1 useful for treating ceramics and comprising from about 0.02% to about 5% by weight of a coacervate complex having a molar charge ratio greater than 0.1 and at least one surfactant.

24. The composition of claim 23 wherein said surfactant is present in an amount of between about 1.5% to about 50% by weight of the composition.

25. The composition of claim 1 useful for cleaning toilets and comprising from about 0.2% to 5% by weight of a coacervate complex having a molar charge ratio greater than 0.1 and an acidic cleaning agent.

26. The composition of claim 25 wherein said acidic cleaning agent is present in an amount of from about 0.1% to about 40% by weight of the composition.

27. The composition of claim 25 further comprising a surfactant in amount of from about 0.5% to about 10% by weight of the composition.

28. The composition of claim 25 further comprising a thickener.

29. The composition of claim 1 useful for treating showers and comprising from about 0.02% to about 5% by weight of a coacervate complex having a molar charge ratio greater than 0.1.

30. The composition of claim 29 further comprising at least one surfactant present in an amount ranging from about 0.5% to about 5% by weight and optionally a metal-chelating agent in an amount from about 0.01% to about 5% by weight.

31. A method comprising applying, treating, or pre-treating a hard surface with a composition according to claim 1.

32. The method of claim 31 wherein the hard surface is selected from the group consisting of glass panels, motor vehicle parts, ceramics, toilets, and showers.
